(19) United States
(12) Patent Application Publication
(10) Pub. No.: US 2021/0334926 A1
(43) Pub. Date: Oct. 28, 2021

(54) SYSTEM AND A METHOD FOR CREATING AND TRANSMITTING AN OCCUPANT SAFETY TEST FOR OCCUPANTS IN AN ORGANIZATION

(71) Applicant: VENN AGENCY, Los Angeles, CA (US)

(72) Inventor: Samantha Mathews, Los Angeles, CA (US)

(21) Appl. No.: 17/240,836

(22) Filed: Apr. 26, 2021

Related U.S. Application Data
(60) Provisional application No. 63/015,655, filed on Apr. 26, 2020.

(51) Int. Cl. G06Q 50/26; G06Q 10/10

(52) U.S. Cl. CPC G06Q 50/265; G06Q 10/10

(57) ABSTRACT

System and a method for creating and transmitting an occupant safety test in an organization. The system receives details of an organization. The organization includes sub-organizations in multiple locations. As such, the system receives details of each location of the organization. Further, each location includes multiple zones. Each zone of the multiple zones includes fixtures. A fixture indicates an area or subarea within the zone including safety equipment or emergency door that is physically present in the zone. The system receives a list of occupants in each zone in the location. Further, the system creates an occupant safety test for each occupant in the zone, by assigning a safety fixture onto to a zone plan of the zone, the safety fixture being indicative of a label created corresponding to the fixture in the zone, the safety fixture the occupant has to identify when executing the occupant safety test. After creating the occupant safety test, the system transmits the occupant safety test to the occupant. The user uses a user device to execute the occupant safety test by identifying protocols corresponding to the safety fixtures on the zone plan of the zone and gets familiarized with the fixtures in the zone.

The present application claims the benefit of U.S. Provisional Application No. 63/015,655, filed Apr. 26, 2020, all of which is incorporated herein by reference.

### FIELD OF INVENTION

The present invention generally relates to providing occupant safety tests to occupants. More specifically, the present invention relates to a system and a method for creating and transmitting occupant safety tests for occupants in an organization such that an occupant can execute an occupant safety test assigned to him and identify a fixture in a location of the organization with the help of a safety fixture affixed corresponding to the fixture onto a zone plan of the zone.

### BACKGROUND OF INVENTION

It is known that open markets, large organizations or facilities or buildings or structures are designed to accommodate people in very large numbers. The facilities include, but not limited to, manufacturing facilities, office buildings, shopping malls, schools, universities, hospitals and so on. Typically, the facilities include emergency exit doors in addition to entry and exit doors. The emergency exit doors are generally provided at strategic locations for allowing occupants of the facility to exit the facility in case of an emergency situation. Further, the facilities include safety equipment such as first aid kit, fire extinguisher, etc. placed at strategic locations for allowing the occupants to use in case of the emergency situation.

In addition, the facilities include audio alert systems, guidance systems having visual representations on walls of the facility, and lighting systems among others designed for guiding the occupants to nearest emergency exit doors. With advent in technology, sensors are deployed across the facility for tracking presence of the occupants and for guiding them to the nearest emergency exit doors. However, in the emergency situation, people tend to panic. It is scientifically proven that during panic situations, parts of the prefrontal cortex involved in thought and reasoning begin to shut down. As a result, people may not react appropriately in the emergency situation and fail to use the safety equipment and follow the guidance systems.

Several systems have been disclosed in the past to provide guidance to users in a facility. One such example for providing directional indication is disclosed in a U.S. Pat. No. 9,754,466, entitled “Guidance indicator and system for providing egress assistance” (the “'466 patent”). The '466 patent discloses a system including a detector (113) configured to sense a condition, a guidance indicator (117) configured to provide an indication regarding a path for egress, and a control unit configured to control the guidance indicator based on a signal from the detector.

An example of a system utilizing sensors for guiding occupants is disclosed in a U.S. Pat. No. 9,761,096, entitled “Active emergency exit systems for buildings” (the “'096 patent”). The '096 patent discloses an active exit system including one or more active exit signs, each exit sign having at least one sensor, a display, and a transceiver. Each active exit sign monitors building environmental conditions, monitors the locations of users and objects within the building, and assists in location services during normal operation. The exit signs transmit a dynamic exit plan to a user's electronic device based on the user's location. In response to sensing an emergency event, the exit sign transmits an emergency signal to the user's electronic device and updates a user's exit plan as needed based on the location of the emergency event. The exit sign also transmits user location information to emergency responders.

An example of an emergency notification and response system is linked to a fire alarm system is disclosed in a U.S. Pat. No. 8,884,772, entitled “Building evacuation system with positive acknowledgment” (the “'772 patent”). The '772 patent discloses an emergency notification and response system is linked to a fire alarm system, a security system and to a communication network over which it sends and receives emergency messages to and from building occupants and to emergency response personnel. The emergency notification and response system comprises a notification module which operates to receive signals from a fire detection system and send one or more messages to building occupants to investigate the validity of a possible fire event, and to respond to the message with an indication that a fire event is in progress or not. Depending upon information received in the response, the notification module sends an evacuation message to a selected sub-set of the building occupants that includes instructions for evacuating the building.

An example of a system and a method for indicating an emergency exit path upon detection of a fire in a building structure is disclosed in a U.S. Pat. No. 9,983,011, entitled “Mapping and facilitating evacuation routes in emergency situations” (the “'011 patent”). The '011 patent discloses a system and method that include detecting a signal indicating presence of the fire in the building structure and determining an evacuation situation is present based on a risk assessment. In response to determining the evacuation situation is present, the systems and methods may include mapping the emergency exit path out of the building structure based on an identified location of the fire and an identified location of a person in the building structure, and operating a plurality of lighting devices in the building structure to indicate the emergency exit path out of the building structure.

Although the above-discussed systems are capable of alerting and guiding the occupants to the nearest emergency exit doors, they have few problems. For example, during an emergency situation such as a fire accident, the occupants tend to panic and forget to pay attention to the audible alarm. In addition, due to smoke, the occupants may not be able to recognize the visual signals or lights indicating a path or route to the nearest emergency exit door. Further, there is no control over the number of people choosing to take a certain path for reaching the nearest emergency exit door which may result in a crowd running towards one emergency exit door. This may lead to unnecessary injuries or even death.

None of the above discussed prior art disclosures disclose a method for creating an occupant safety test for each occupant in an organization to familiarize the occupant with the fixtures in the zone such that the occupant can reach to safety with ease or may alert emergency personnel quickly which can save lives and resources of the organization.

Consequently, there is a need for an improved system and method for creating and transmitting occupant safety tests for occupants in an organization, such that the occupants are familiarized with zones, and safety fixtures and corresponding protocols to be followed to operate the fixtures in case of an emergency.

### SUMMARY

It is an object of the present invention to provide a system and a method for creating and transmitting occupant safety tests for occupants in an organization and that avoids the drawback of known techniques.

It is another object of the present invention to provide a system that creates and assigns occupant safety test for each occupant of an organization in every location, which the occupant can get familiarized with the safety fixtures in the zone for use in an emergency situation to ensure his and others safety.

In order to achieve the object, the present invention provides a system and a method for creating and transmitting an occupant safety test for each occupant or occupants in a zone in a location of an organization such that the occupants can identify safety fixtures affixed onto a zone plan of the zone by executing the occupant safety test thereby familiarizing with the fixtures and protocols in the zone.

In one technical feature of the present invention, the system receives details of the organization. The organization may include several branches situated in one or more locations. As such, the system receives details of each location of the organization. Each location further includes multiple zones. Each of the zones includes several fixtures, each indicating an area including safety equipment or emergency door that is physically present in the zone. Accordingly, the system receives the details of the organization, the location and the zones.

After receiving the details of the organization, the location and the zones, the system creates an occupant safety test for each of the occupant of the zone in the location. The occupant safety test is a test assigned to an occupant to identify a safety fixture affixed or imposed onto a zone plan of the zone to indicate a physical fixture (location/equipment) and protocols to be followed in using/operating the fixture in the zone. The zone plan indicates a digitized floor plan of the zone. Here, the zone plan is generated by superimposing safety fixtures over physical location of the fixtures in the zone. As specified above, a fixture indicates an area or subarea within the zone including safety equipment or emergency door that is physically present in the zone. For example, the fixture includes a primary exit door, a secondary exit door, an area including a telephone, an area including a first aid kit, a muster station and so on. A safety fixture indicates a label or symbol affixed or imposed (superimposed) onto the zone plan used for identifying certain portions or component(s) i.e., the fixture in the zone.

In accordance with the present invention, the system creates the occupant safety test. The occupant safety test indicates a test created for the occupant in the zone to identify a safety fixture corresponding to the physical fixture in the zone in order to get familiarized with the physical location of the fixtures in the zone for use in an emergency situation. Here, the system creates the occupant safety test by assigning the occupant in the zone in the location such that the occupant safety test is personalized for the occupants in the zone. By assigning the superimposed safety fixtures onto the zone plan to allow the occupant to identify the fixtures in the zone, the system ensures that the occupant identifies the accurate physical location corresponding to the safety fixtures in the zone plan. In other words, the system allows the occupants to get familiarized with the safety fixtures and operating instructions/protocols to operate the fixtures in the zone so as to build a spatial map or cognitive map in the minds of the occupants to follow in an emergency situation.

After creating the occupant safety test, the system transmits the occupant safety test to the occupant. The occupant uses a user device to take or execute the occupant safety test. Specifically, the occupant executes the occupant safety test by identifying the safety fixtures on the zone plan of the zone displayed to him and familiarizes with the safety fixtures in the zone. For example, the system creates the occupant safety test for an occupant in a zone such that the occupant executes the occupant safety test e.g., watching a video including visual/audio instructions to operate the fixtures and to obtain full information about the fixtures present in the zone such that the occupant is trained or familiarized early on with the safety fixtures associated with the fixtures so as to follow in the emergency situation.

It one advantageous feature of the present invention, the system ensures that each occupant is familiarized with the fixtures and protocols in the zone. The occupant follows the protocols and instructions based on the knowledge gained from the occupant safety test in an emergency situation and reaches to his and others' safety. This ensures their safety in the emergency situation and occupant(s) can further alert emergency personnel to come to their aid.

Features and advantages of the subject matter hereof will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present invention will become apparent from the following detailed description, taken in combination with the appended drawings, in which:

FIG. 1 illustrates an environment in which a system for creating and transmitting an occupant safety test is implemented, in accordance with one embodiment of present invention;

FIG. 2 illustrates a diagrammatic representation of the system, in accordance with one embodiment of present invention;

FIG. 3 illustrates a block diagram of a user device, in accordance with one embodiment of the invention;

FIG. 4 illustrates a method of creating an occupant safety test for an occupant of an organization, in accordance with one embodiment of the invention;

FIG. 5 illustrates a method of creating and transmitting or sending an occupant safety test to an occupant of an organization, in accordance with one embodiment of present invention;

FIG. 6 illustrates an exemplary login page or dialog box prompted to an administrator by the system to login to the system, in accordance with one embodiment of present invention;

FIG. 7 illustrates a screenshot showing a subsection when selected displays the details of the organization, in accordance with one embodiment of present invention;

FIG. 8 illustrates the screenshot showing a subsection showing details of the occupant retrieved from main memory and displayed on the video display, in accordance with one embodiment of present invention;

FIG. 9 illustrates a screenshot showing the administrator being prompted to add new location in subsection, in accordance with one exemplary embodiment of present invention;

FIG. 10 illustrates the screenshot in which the system prompts the administrator to add or create new zone in subsection, in accordance with one exemplary embodiment of present invention;

FIG. 11 illustrates an exemplary zone plan of the zone within the location upon which the safety fixtures are added, in accordance with one exemplary embodiment of present invention;

FIG. 12 illustrates a screenshot showing subsections for assigning the location and zone to an occupant, in accordance with one exemplary embodiment of present invention;

FIG. 13 illustrates an example in which the occupant safety test is created and sent to the occupant, in accordance with one exemplary embodiment of present invention;

FIG. 14 illustrates a method of receiving and executing the occupant safety test by the occupant, in accordance with one exemplary embodiment of present invention;

FIG. 15 illustrates an exemplary login page or dialog box prompted to the occupant to login to the system to access the link or email, in accordance with one exemplary embodiment of present invention; and

FIG. 16 illustrates a screenshot showing a subsection, displaying the occupant safety test in which the occupant is prompted to identify the safety fixtures in the zone, in accordance with one exemplary embodiment of present invention.

It will be noted that throughout the appended drawings, like features are identified by like reference numerals.

### DETAILED DESCRIPTION OF THE EMBODIMENTS

Before the present features and working principle of a system for creating and transmitting an occupant safety test is described, it is to be understood that this invention is not limited to the particular system as described, since it may vary within the specification indicated. Various features of the system for creating and transmitting an occupant safety test might be provided by introducing variations within the components/subcomponents disclosed herein. It is also to be understood that the terminology used in the description is for the purpose of describing the particular versions or embodiments only, and is not intended to limit the scope of the present invention, which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

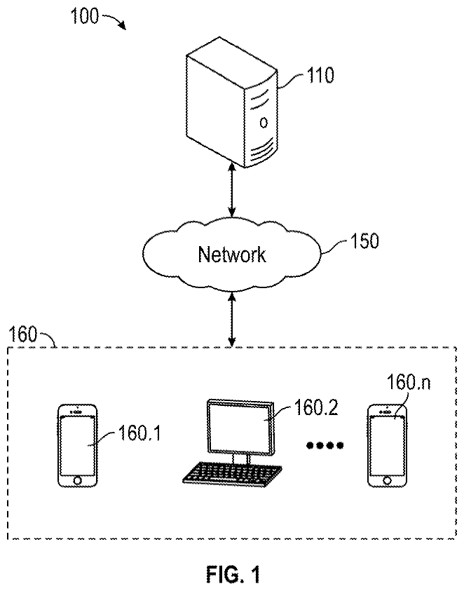

It should be understood that the present invention describes a system and a method for creating and transmitting an occupant safety test in an organization. The system receives details of an organization. The organization might be present in multiple locations. As such, the system receives details of each location of the organization. Further, each location includes multiple zones. Each zone of the multiple zones includes fixtures. A fixture indicates an area or subarea within the zone including safety equipment or emergency door that is physically present in the zone. The system receives a list of occupants in each zone in the location. Further, the system creates an occupant safety test for each occupant in the zone, by assigning a safety fixture onto to a zone plan of the zone, the safety fixture being indicative of a superimposed label/image/diagram of a fixture in the zone, that the occupant has to identify when executing the occupant safety test. After creating the occupant safety test, the system transmits the occupant safety test to the occupant. The user uses a user device to execute the occupant safety test by identifying the safety fixtures on the zone plan of the zone thereby familiarizing with the fixtures in the zone. Various features and embodiments of the system for creating and transmitting an occupant safety test are explained in conjunction with the description of FIGS. 1-16.

In one embodiment, the present invention discloses a system for creating and transmitting an occupant safety test data. FIG. 1 shows environment 100 in which system 110 is implemented. Environment 100 includes system 110, and plurality of user devices 160.1, 160.2 . . . 160.n collectively referred as user devices 160 or simply user device 160. As can be seen, system 110 and user devices 160 communicatively connect to each other via network 150.

System 110 includes an electronic device such as a mobile phone, a laptop, a tablet, a computer and so on. System 110 presents hardware and/or one or more applications configured to execute functions for creating an occupant safety test for occupants in an organization. In one embodiment, system 110 implements as a standalone device or connects (e.g., networked) to other systems via network 150. In another embodiment, system 110 implements as a client-server architecture, in that system as acts a server 110 and communicates with one or more client or user devices 160 over network 150.

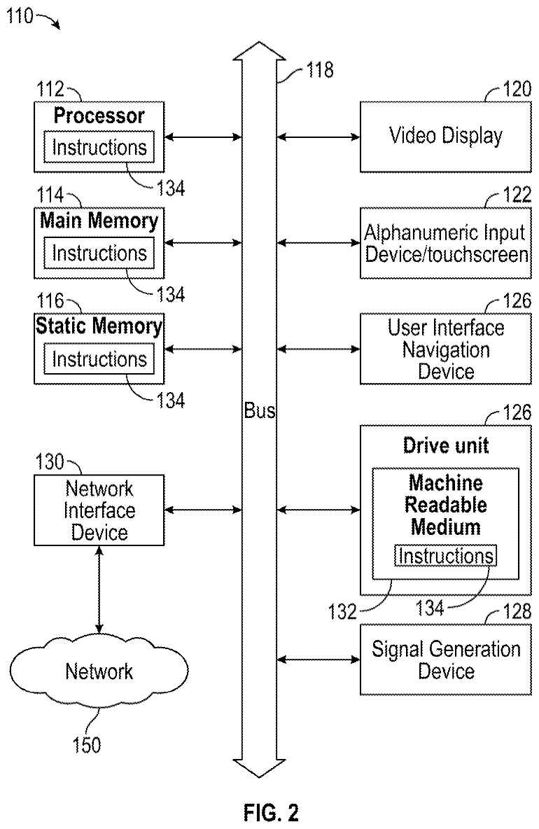

FIG. 2 shows a diagrammatic representation of system 110, in accordance with one embodiment of present invention. System 110 includes processor 112 (e.g., a central processing unit (CPU), graphics processing unit (GPU) or both), main memory 114 and static memory 116, which communicate with at least one other via bus 118.

Processor 112 includes any suitable processing device, such as a microprocessor, microcontroller, integrated circuit, logic device, or other suitable processing device.

Main memory 114 includes one or more computer-readable media, including, but not limited to, non-transitory computer-readable media, RAM, ROM, hard drives, flash drives, or other memory devices. Main memory 114 stores information accessible by processor 112, including computer-readable instructions 134 that are executed by processor 112. Instructions 134 include any set of instructions that when executed by processor 112, cause processor 112 to perform operations.

In one example, main memory 114 stores data that can be retrieved, manipulated, created, or stored by processor 112. The data includes, for instance, organizational data, occupants' data, zone data, and other data.

Bus 118 provides a mechanism for letting the various components and subsystems of system 110 communicate with each other as intended. Although bus 118 is shown schematically as a single bus, alternative embodiments of bus 118 utilizes multiple buses. Bus 118 includes any of several types of bus structures including a memory bus or memory controller, a peripheral bus, and a local bus using any of a variety of bus architectures. For example, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

System 110 includes video display unit 120 (e.g., a liquid crystal display (LCD) or a cathode ray tube (CRT)). System 110 further includes an alphanumeric input device (e.g., a keyboard) and/or touchscreen 122, user interface (UI) navigation device 124 (e.g., a mouse), disk drive unit 126, signal generation device 128 (e.g., a speaker), and network interface device 130.

Disk drive unit 126 includes machine-readable medium 132 on which is stored one or more sets of instructions and data structures (e.g., software 134) embodying or utilized by any one or more of the methodologies or functions described herein. It should be understood that the term “machine-readable medium” includes a single medium or multiple media (e.g., a centralized or distributed database, and/or associated caches and servers) that stores the one or more sets of instructions. The term “machine-readable medium” includes any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” may accordingly be taken to include, but not be limited to, solid-state memories, optical and magnetic media, and carrier wave signals.

Instructions 134 resides, completely or at least partially, within main memory 114 and/or within processor 112 during execution thereof by system 110, main memory 114 and processor 112 also constituting machine-readable media. Instructions 134 get transmitted or received over network 150 via network interface device 130 utilizing any one of a number of well-known transfer protocols.

System 110 exchanges data with user devices 160 over network 150, as shown in FIG. 1. A person skilled in the art understands that plurality of user devices 160 includes one or any number of user devices 160 that connect to system 110 over network 150. Each of user devices 160 indicates a suitable type of computing device, such as a general purpose computer, special purpose computer, laptop, desktop, mobile device, navigation system, smartphone, tablet, wearable computing device, a display with one or more processors, or other suitable computing device. For instance, in some implementations, user device 160 includes a mobile user device, or a non-mobile user device.

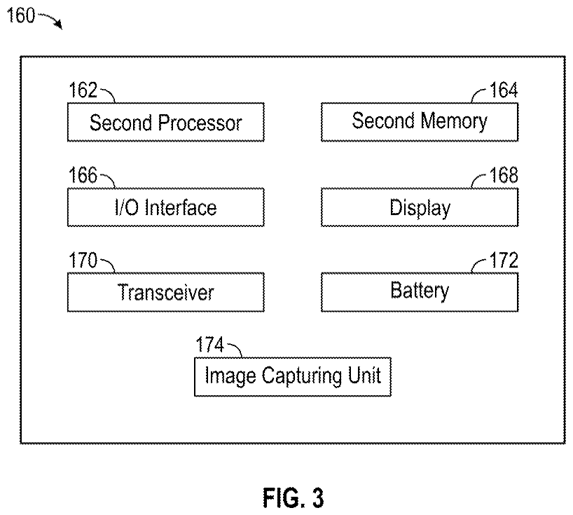

Similar to system 110, each of user devices 160 includes second processor 162 and second memory 164, as shown in FIG. 3. Second processor 162 encompasses a central processing unit (CPU), a graphic processing unit (GPU) dedicated to efficiently rendering images or performing other specialized calculations, and/or other processing devices. Second memory 164 includes a computer-readable media that stores information accessible by processor 162, including instructions that can be executed by processor 162 and data.

User device 160 further includes various input/output devices for providing and receiving information from a user, such as a touch screen, touch pad, data entry keys, speakers, and/or a microphone suitable for voice recognition. For instance, user device 160 includes an input/output interface 166 and display 168. Display 168 presents a user interface configured for displaying information such as a zone plan of a zone and affixing or imposing safety fixtures onto the zone plan of the zone according to example aspects of the present disclosure.

User device 160 includes a network interface such as transceiver 170 used for communicating with one or more remote computing devices (e.g. system 110) over network 150. Further, user device 160 includes battery 172 such as a rechargeable battery for powering user device 160.

User device 160 further includes a network interface such as image-capturing unit 174 such as a camera used for capturing still images or video. A person skilled in the art understands that image-capturing unit 174 helps to scan codes such as a Quick Response (QR) code. Image-capturing unit 174 scans the QR code and transmits the information to second processor 162 for processing the information.

Network 150 includes any type of communications network, such as a local area network (e.g. intranet), wide area network (e.g. Internet), cellular network, or some combination thereof. Network 150 includes a direct connection between user device 160 and system 110. In general, the communication between system 110 and user device 160 can be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skilled in the art will recognize that the inherent flexibility of computer-based systems allows for a great variety of possible configurations, combinations, and divisions of tasks and functionality between and among components. For instance, system or server processes discussed herein may be implemented using a single server or multiple servers working in combination. Data and the applications might be implemented on a single system or distributed across multiple systems. Distributed components may operate sequentially or in parallel.

In accordance with one embodiment of the present invention, system 110 creates and transmits an occupant safety test for an occupant in an organization. As such, an administrator or an owner of the organization operates system 110. In order to operate system 110, the administrator registers himself with system 110. For instance, the administrator registers himself by providing his details such as Name, Email address, telephone number and so on. After providing the details, system 110 prompts the administrator to provide a password to securely authenticating him to access system 110. After providing the email address and password, system 110 registers the details of the administrator. Specifically, processor 112 receives the details of the administrator and instructs main memory 114 to store the details.

In the current embodiment, the organization includes, but not limited to, a hospital, a manufacturing facility, a school, an office building, a university, a shopping mall and so on. As known, the organization situates in one or more locations. In accordance with current embodiment, a location indicates a building or structure or vehicle belonging to the organization. In each location, the organization includes multiple zones. In other words, a location indicates a building/structure/vehicle belonging to an organization that contains multiple zones. For example, consider an organization named Seaspan is located in Vancouver with an address 50 Pemberton Avenue, then in accordance with current embodiment, Seaspan is the organization and 50 Pemberton is the location. Further, the location includes multiple zones e.g., Zone 2A, Zone 2B, etc. in which a location is subdivided into multiple smaller sections/locations of manageable size based on the occupancy capacity of the occupants in the organization. The zones are created based on several factors such as occupancy rate, airflow, area in square footage, type of occupants or machinery to be used, etc. A person skilled in the art understands that zones are created based on any other factors, including, but not limited to, size of the location, number of occupants in the location at any given point of time and/or as needed by the organization.

Each of the zones includes one or more fixtures. A fixture indicates an area including safety equipment or emergency door or safety room or safety section that is physically present in the zone. For example, Zone 2A includes fixtures such as a primary exit door, a secondary exit door, an area including a telephone, an area including a first aid kit, a muster station and so on. Similarly, Zone 2B includes fixtures such as a primary exit door, an area including a telephone, an area including a first aid kit, and so on. Each of the zones including the fixtures are digitized as an index (Application programming interface (API) index), in that a zone plan of the zone is digitized and markings/safety fixtures are affixed or superimposed onto the zone plan accurately marking the physical location of the fixtures in the zone. A person skilled in the art understands that the zone plan indicates a digitized floor plan of the zone. Here, system 110 generates or creates the zone plan by superimposing the safety fixtures corresponding to the physical location of the fixtures in the zone. The zone plan including the safety fixtures is then provided to the occupant of the zone to identify the physical fixtures with ease. In other words, the physical fixtures are mapped onto a zone plan of the zone with markings or safety fixtures such that the occupants get familiarized in identifying the physical fixtures in the zone with the help of the safety fixtures on the zone plan. Each safety fixture is assigned with longitude and latitude coordinates and logged into the map. Further, each of the safety fixtures is tagged with information such as location of the fixture and protocol that needs to be followed by an occupant in operating the fixture. This is done to allow the occupant to interact with system 110 to obtain more information such as diagrams, maps, etc. corresponding to the fixtures in the zone.

An occupant indicates a person being employed or present in one or more zones in a location of the organization. In one example, the occupant indicates an employee of the organization assigned with a designated workstation to perform a designated task. In another example, the occupant indicates a visitor the zone for a specific duration.

In order to familiarize the occupant with the fixtures in the zone, the present invention facilitates in creating an occupant safety test for the occupant. The occupant safety test is specifically configured for each occupant or a plurality of occupants present in a zone in a location. The occupant safety test is a test created specifically for an occupant in a zone to identify a safety fixture affixed or superimposed on a zone plan of the zone to indicate a physical fixture in the zone. The safety fixture indicates a label or symbol on the zone plan used for identifying certain portions or components i.e., fixtures in the zone. For example, consider that a first aid kit symbol or image is affixed on the zone plan to indicate the location of the first aid kit in the zone. Further, a telephone symbol is affixed on the zone plan to indicate the location of the telephone in the zone. Further, a muster station symbol or image is affixed on the zone plan to indicate the location of the muster station in the zone. Similarly, other safety fixtures are affixed onto the zone plan to indicate different safety locations in the zone.

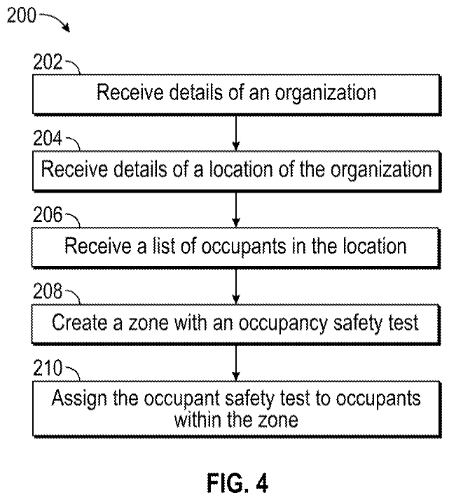

A method of creating an occupant safety test for an occupant of an organization is explained using FIG. 4. FIG. 4 illustrates method 200 of creating an occupant safety test for an occupant of an organization, in accordance with one embodiment of the present invention. The order in which method 200 is described should not be construed as a limitation, and any number of the described method blocks can be combined in any order to implement method 200 or alternate methods. Additionally, individual blocks may be deleted from method 200 without departing from the spirit and scope of the subject matter described herein. Furthermore, method 200 can be implemented in any suitable hardware, software, firmware, or combination thereof. However, for ease of explanation, in the embodiments described below, method 200 implements using the above-described system 110.

In order to create an occupant safety test for an occupant in an organization, at first, system 110 receives details of the organization, as shown at step 202. For example, system 110 receives details of the organization such as the name of the organization. Further, if the organization includes a plurality of sub-organizations indicating subsidiaries of the organization situated at different locations, then system 110 receives the details of each of the location of the organization, as shown at step 204.

As presented above, the organization situates in one or more locations, say as subsidiaries or spread out as multiple branches. As such, if the organization is present in more than one location, then system 110 receives details of the organization for each of the locations. In accordance with present embodiment, a location indicates a building or structure or vehicle belonging to the organization.

After receiving the details of the organization and the locations, system 110 receives a list of occupants in the location, as shown at step 206. As specified above, the occupant indicates a person employed or present in the structure of the organization. For each of the occupants, system 110 receives the occupant's name, identification number (ID) such as an employee ID, name of a department in which the occupant is assigned or designated to work and so on. After receiving the list of the occupants, system 110 configures with knowledge of protocols to be followed in each zone of the location where the occupant is designated to perform his assigned task. Subsequently, system 110 assigns the protocols to be followed in each zone of the location where the occupant is designated to perform his assigned task, as shown at step 208. As presented above, the location is divided into multiple zones for easy identification of one or more departments or sections in which a variety of tasks are performed by the occupants. In other words, a zone is indicative of an area within the location of the organization in which an occupant performs a given task. Here, the occupant performs the same or different tasks in one location. Alternatively, the occupant performs the same or different tasks in one location.

After receiving the details of each occupant, system 110 creates a zone with an occupant safety test for the occupant, as shown at step 208. In other words, system 110 creates the occupant safety test for each of the occupants in a zone. As such, system 110 creates different occupant safety tests for occupants in different zones.

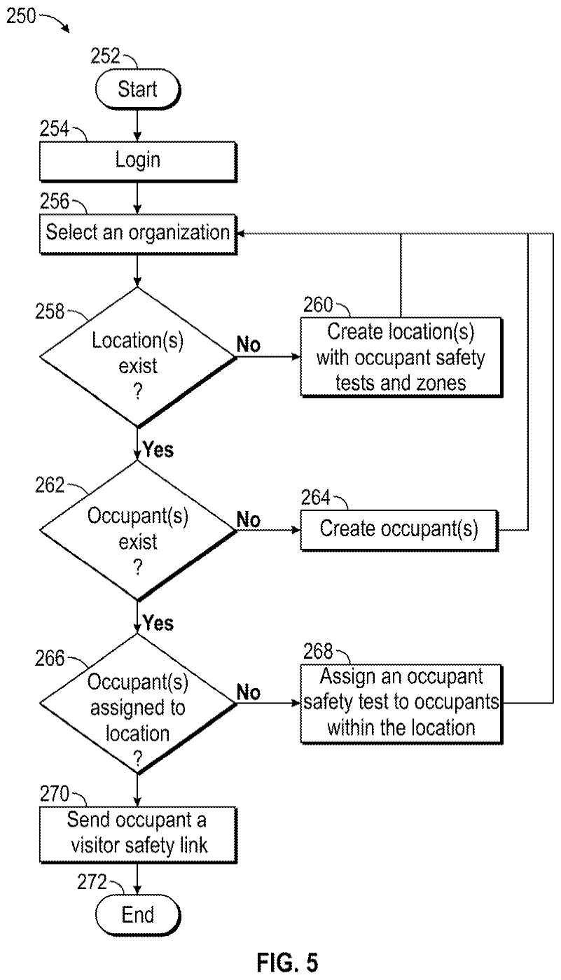

Further, system 100 assigns the occupant safety test created for the occupants within the zone, as shown in step 210. It should be understood that system 110 assigns the occupant safety test to each of the occupants in each of the zones in the location. Creation of the occupant safety test and assigning the occupant safety test to an occupant to identify a safety fixture affixed onto a zone plan of the zone is explained in detail in the later part of the description with the help of FIG. 5.

After assigning the occupant safety test for each occupant in the zone of the location belonging to the organization, information corresponding to the location, zone and the occupant safety test get stored in main memory 114 of system 110. Although it is presented that details of one organization present different locations, each location including multiple zones is received and stored in main memory 114, it should be understood that the above process is repeated for receiving details from more than one organization and the details are stored in main memory 114.

Now referring to FIG. 5, method 250 of creating and transmitting or sending an occupant safety test to an occupant of an organization is explained, in accordance with one embodiment of the present invention. The order in which method 250 is described should not be construed as a limitation, and any number of the described method blocks can be combined in any order to implement method 250 or alternate methods. Additionally, individual blocks may be deleted from method 200 without departing from the spirit and scope of the subject matter described herein. Furthermore, method 250 can be implemented in any suitable hardware, software, firmware, or combination thereof. However, for ease of explanation, in the embodiments described below, method 250 implements using the above-described system 110.

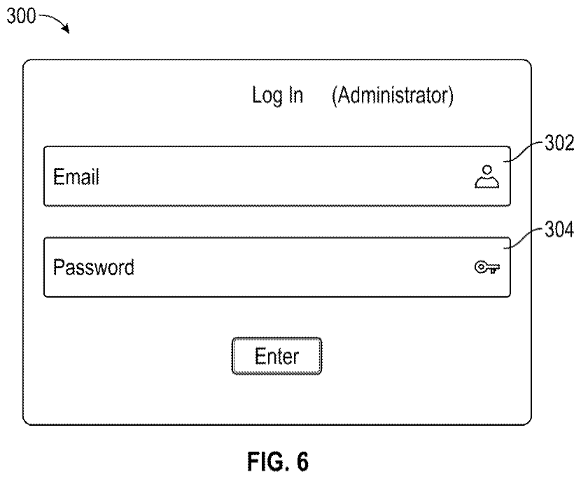

Method 250 begins at step 252. In order to create an occupant safety test for an occupant, system 110 prompts the administrator to login to system 110 by providing his email address and the password registered with system 110, as shown at step 254. FIG. 6 shows an exemplary login page or dialog box 300 that system 110 prompts to the administrator. As can be seen, login page 300 includes subsections 302 and 304 for receiving the email address and password, respectively from the administrator. Upon being prompted, the administrator provides his email address and password registered with system 110. After receiving the email address and password, processor 112 verifies the email address and password with the email address and password stored in main memory 114. If the email address and password match, then system 110 provides access to the administrator.

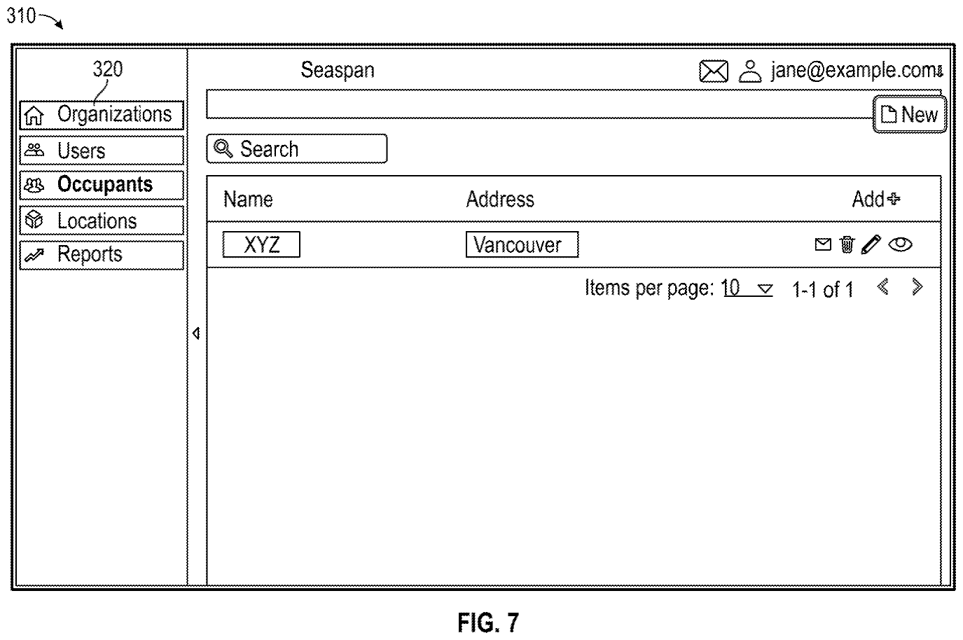

After accessing system 110, system 110 allows the administrator to select an organization from a list of organizations stored in main memory 114, as shown at step 256. As specified above, system 110 stores the details of organizations in main memory 114. As such, the administrator provides an input i.e., name of the organization in system 110 using alphanumeric input device and/or touchscreen 122. After receiving the input, system 110 retrieves the details of the organization from main memory 114. FIG. 7 shows screenshot 310 encompassing subsection 312 that displays the details of the organization upon selection. As can be seen, system 110 displays the name of the organization and address of the organization.

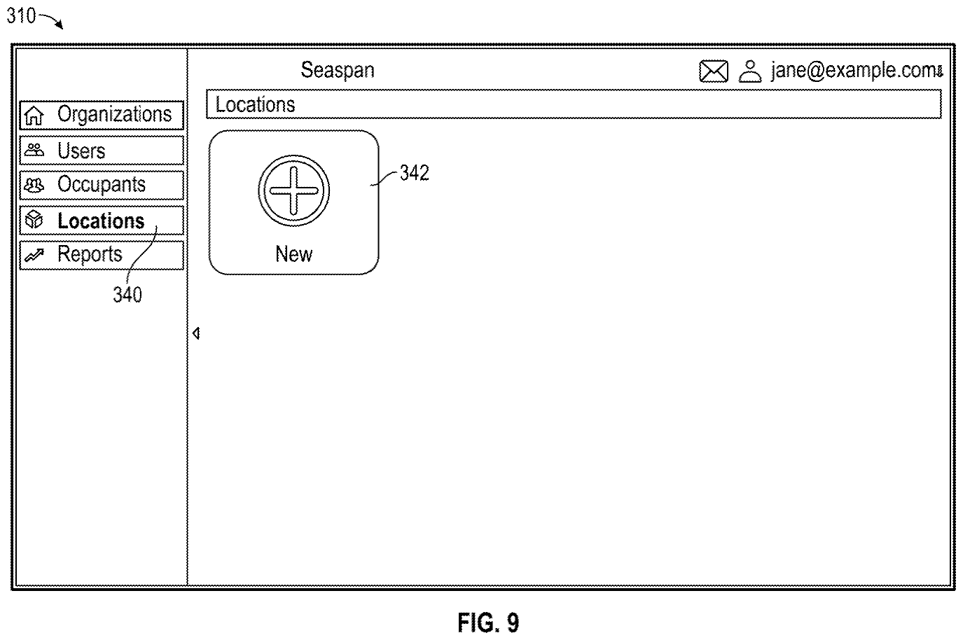

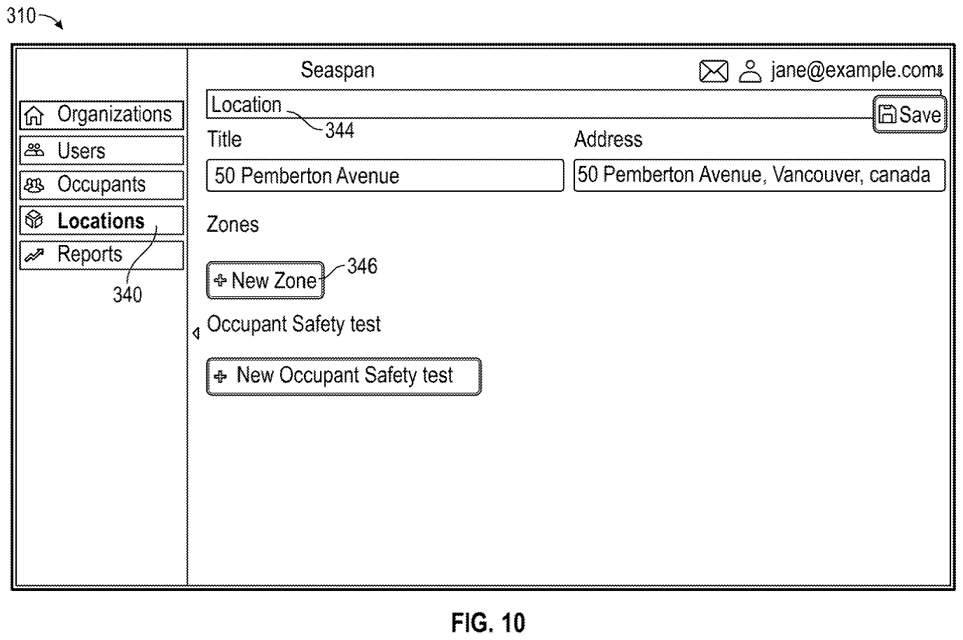

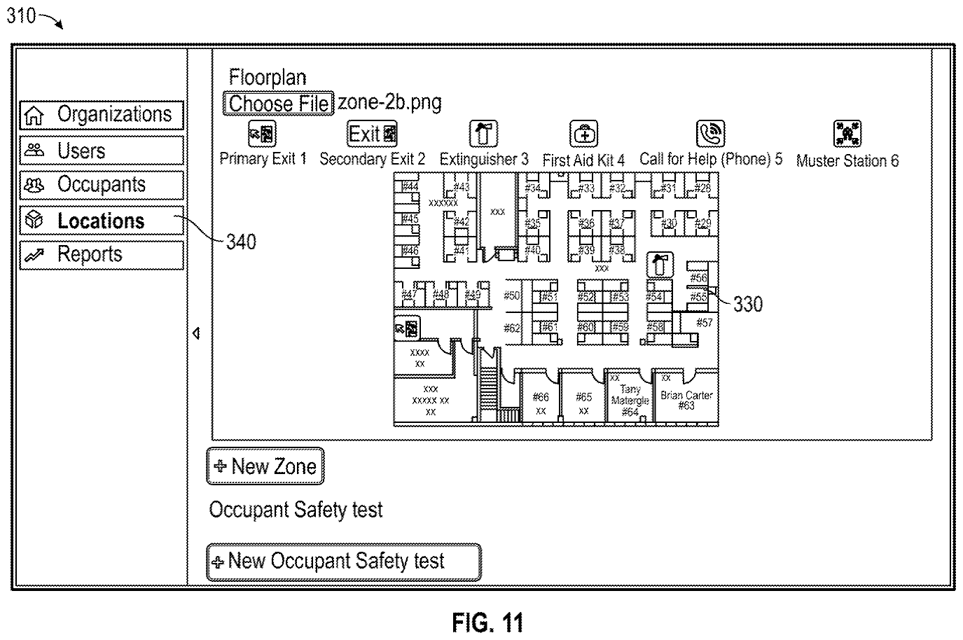

After selecting the organization at step 256, method moves to step 258. At step 258, system 110 checks if location of the occupant is added. If the location of the occupant is not added in system 110, then system 110 prompts the administrator to create a new location for the occupant, as shown at step 260. FIG. 9 shows screenshot 310 having subsection 342. Here, system 110 prompts the administrator to add a new location in subsection 342. Specifically, system 110 prompts the administrator to add the new location by entering the name and address of the physical location for the occupant. After adding the location, system 110 prompts the administrator to create zones with fixtures within the location subsection 340 to identify the fixtures in the zone. FIG. 10 illustrates screenshot 310 in which system 110 prompts the administrator to add or create a new zone in subsection 346. In order to create the zone, the administrator adds a nomenclature or name for the zone. Further, the administrator gets prompted to upload a zone plan of the zone. After uploading the zone plan, system 110 prompts the administrator to drag and drop safety fixtures onto the zone plan. As specified above, the safety fixture indicates a label or symbol affixed or imposed onto the zone plan used for identifying certain portions or components in the zone e.g., the exit doors, first aid kit and so on. FIG. 11 shows an exemplary zone plan of the zone within the location upon which the safety fixtures are added. Here, the administrator drags and drops a safety fixture indicating an emergency exit onto the zone plan. Similarly, the administrator drags and drops other safety fixtures for mapping location of fixtures such as a primary exit, a secondary exit, an extinguisher, a first aid kit, call for help, and a muster station and so on.

In one implementation, the safety fixtures are attached with a video such that the video is played to the occupant to identify the safety fixtures on the zone plan when the occupant takes the occupant safety test.

In another implementation, the safety fixtures are configured in the form of a Quick Response (QR) code such that the occupant can use image-capturing unit 174 of user device 160 to scan and retrieve the occupant safety test assigned to him to identify the safety fixtures on the zone plan indicating the fixtures in the zone.

If the details of the location exist in system 110 at step 258, then system 110 retrieves the details of the location, and method 250 moves to step 262. At step 262, system 110 checks if the location includes occupants. In other words, system 110 checks if the list of occupants is already present in main memory 114. If the list of occupants is not present indicating that details of the occupants of the organization is not added to system 110, then system 110 prompts the administrator to create or add list of occupants, as shown at step 264. In order to create or add details of the occupant in system 110, the administrator provides the occupant's name, identification number (ID) such as an employee ID, name of a department in which the occupant is assigned or designated to work and so on. After adding the details of the occupant, method 250 returns to step 256. Further, if more occupants' details are to be added, then step 264 is repeated.

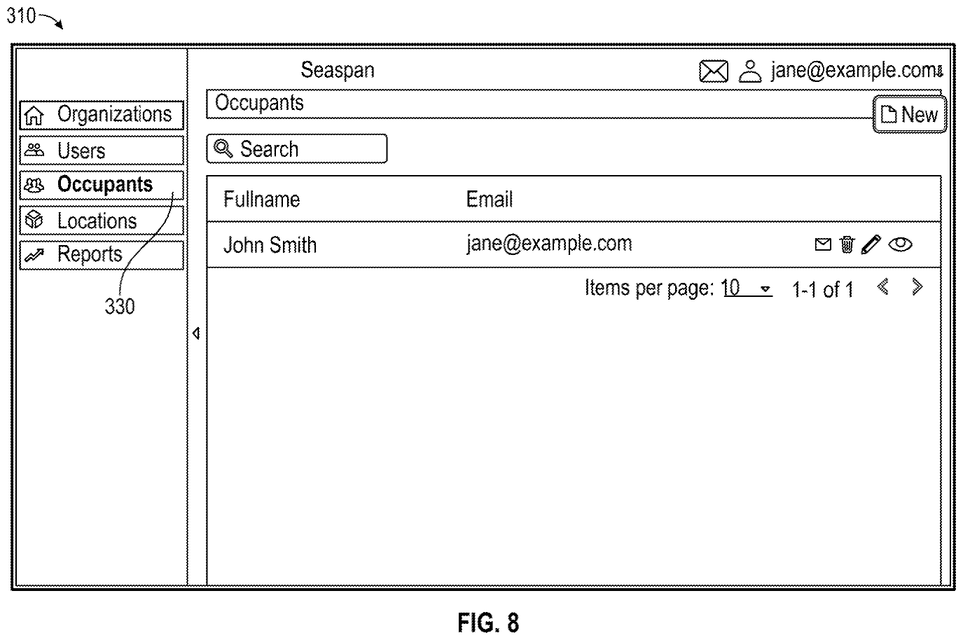

FIG. 8 illustrates screenshot 310 including subsection 330. Subsection 330 shows details of the occupant such as the name and email of the occupant retrieved from main memory 114 and displayed on the video display 120, in accordance with one exemplary embodiment of the present invention.

If the details of the occupants exist in system 110 at step 262, then method 250 moves to step 266.

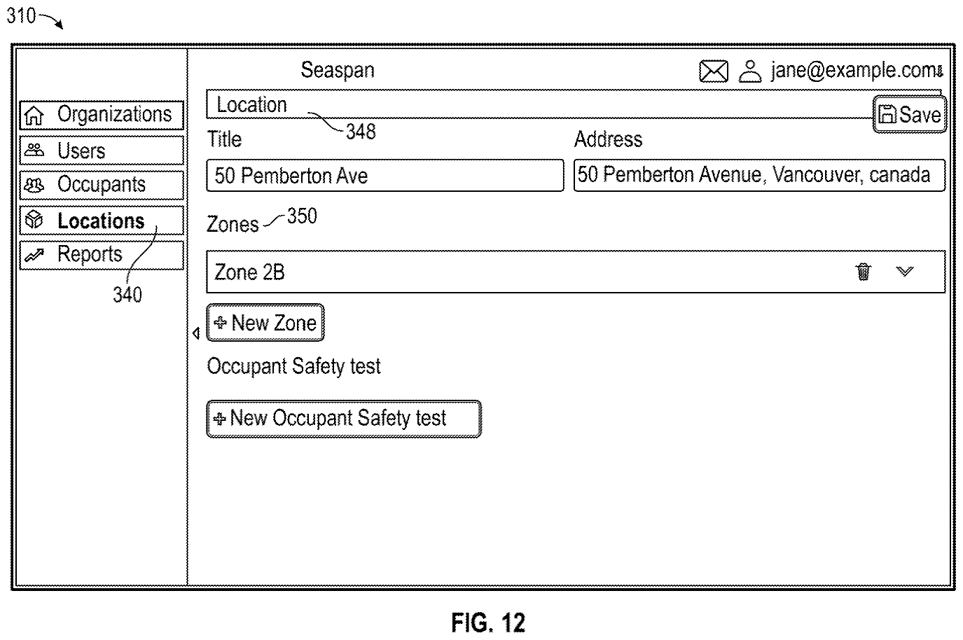

FIG. 12 shows screenshot 310 illustrating a location i.e., subsection 348 and zone i.e., subsection 350 assigned to an occupant. At step 266, system 110 checks if a zone and a location are assigned to the occupant. If the zone and the location are not assigned to the occupant, then system 110 creates an occupant safety test by assigning the occupant to a zone and location for creating the occupant safety test, as shown at step 268. In order to create the occupant safety test, the administrator selects the safety fixtures that the occupant should identify in the occupant safety test. For example, system 110 assigns the occupant to identify safety fixtures corresponding to a fixture such as a primary exit, a secondary exit, an extinguisher, a first aid kit, call for help, and a muster station and so on.

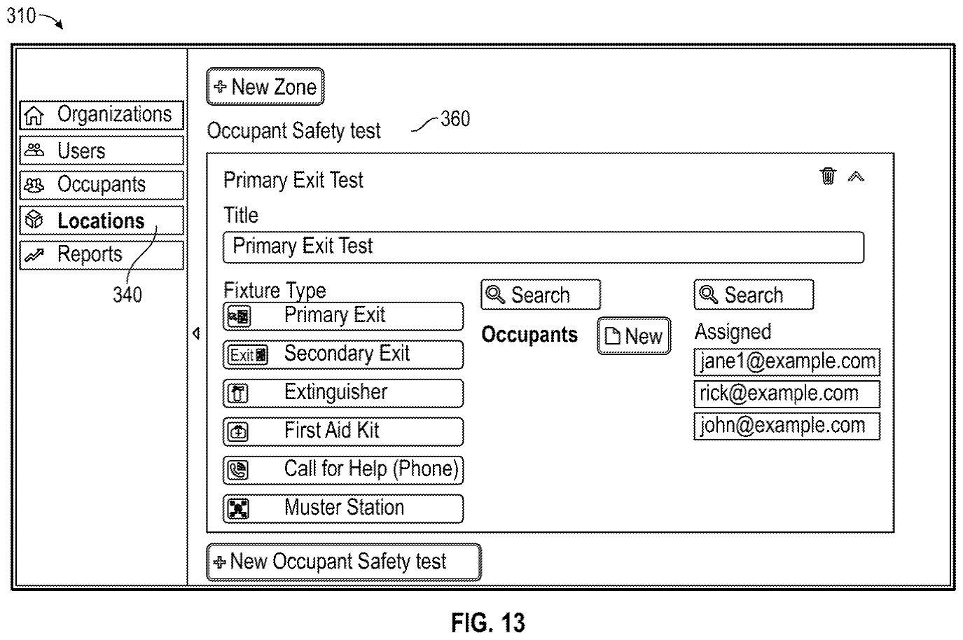

After creating the occupant safety test, method 250 moves to step 270. At step 270, system 110 sends or transmits the occupant safety test created to the occupant. In order to transmit the occupant safety test to the occupant, system 110 prompts the administrator to enter the email address of the occupants required to take the occupant safety test. FIG. 13 shows screenshot 310 illustrating an example in which the occupant safety test 360 is created and sent to the occupant. In one example, the occupant safety test is transmitted to the occupant via an email address of the occupant. In another example, system 110 generates a link i.e., Uniform Resource Locator (URL) with the details of the occupants such that the occupants can access system 110 using the link containing the occupant safety test. After sending or transmitting the link or email to the occupant to access or take the occupant safety test, method 250 ends at step 272.

After sending the link or email with the occupant safety test to the occupant, the occupant accesses the link or email by logging into system 110 with his details. In order to access system 110 using the link or email, the occupant uses user device 160.

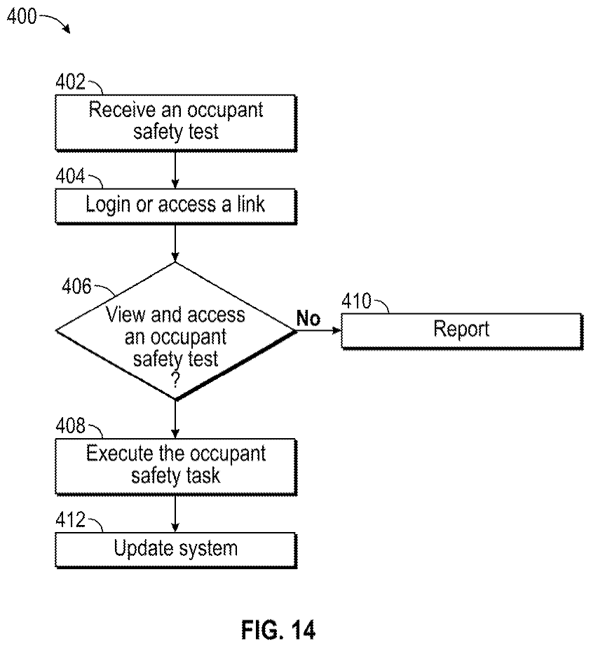

FIG. 14 shows a method 400 of receiving and executing the occupant safety test assigned, by an occupant, in accordance with one embodiment of the present invention. The order in which method 400 is described should not be construed as a limitation, and any number of the described method blocks can be combined in any order to implement method 400 or alternate methods. Additionally, individual blocks may be deleted from method 400 without departing from the spirit and scope of the subject matter described herein. Furthermore, method 400 can be implemented in any suitable hardware, software, firmware, or combination thereof. However, for ease of explanation, in the embodiments described below, method 400 implements using the above-described user device 160.

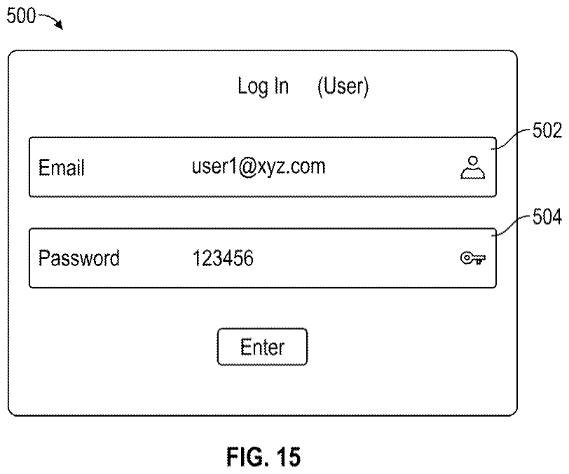

At step 402, the occupant receives the occupant safety test assigned to him from system 110. After receiving, the occupant uses his user device 160 to login to system 110 or access the link using a third party web browser, as shown at step 414. FIG. 15 shows an exemplary login page or dialog box 500 prompted to the occupant by user device 160 to login to system 110 to access the link or email. As can be seen, login page 500 includes subsections 502 and 504 for receiving the email address and password, respectively from the occupant. Upon being prompted, the occupant provides his email address and password registered with system 110 to access system 110.

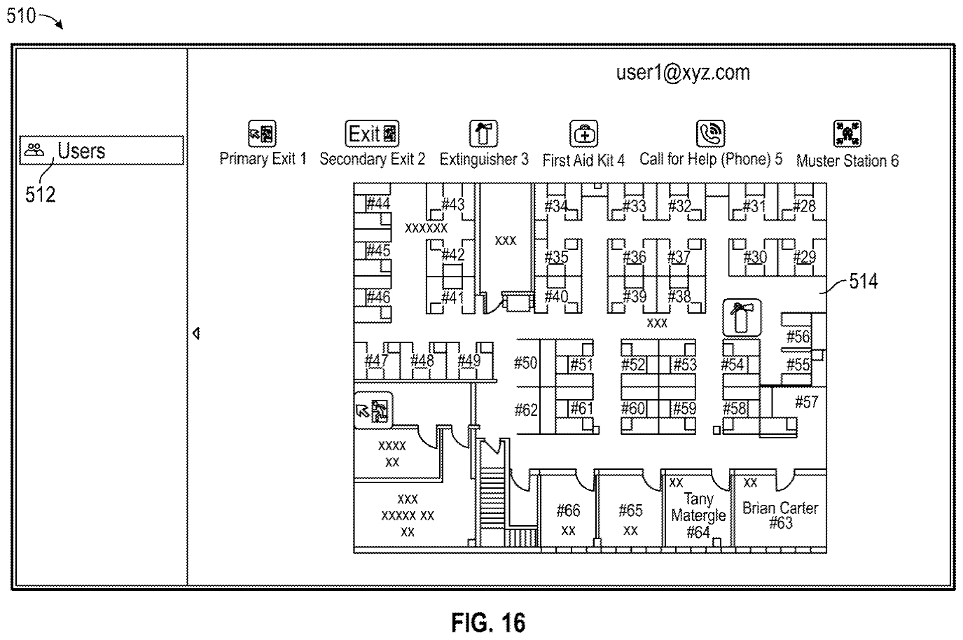

Subsequently, user device 160 checks whether the occupant is able to view and access the occupant safety test assigned to him. If the occupant is able to view and access the occupant safety test assigned to him, then the occupant safety test assigned to him gets displayed such that the occupant can access and execute the occupant safety test, as shown at step 408. FIG. 16 shows screenshot 510 showing a subsection 512, displaying occupant safety test 514 in which the occupant is prompted to identify the safety fixtures in the zone. When the occupant safety test is being executed, the user identifies the safety fixtures on the zone plan of the zone and gets familiarized with the physical location of the fixtures corresponding to the placement of the safety fixtures on the zone plan.

If the occupant is not able to view or access the link to the occupant safety test at step 406, then the occupant reports to the administrator operating system 110 to allow him to access the occupant safety test.

It should be understood that the occupant safety test is created and assigned for new occupants or existing occupants. In one implementation, the system configures to automatically create the occupant safety test periodically e.g., once in three months such that the occupants are familiarized with all safety fixtures even if any physical change is made to the fixture in the zone.

Based on the above, it is evident that the occupant safety test is assigned for each occupant of an organization in every location. By assigning the occupant safety test to each occupant in the organization, each occupant gets familiarized with the safety fixtures in the zone, which the occupant can utilize in an emergency situation to ensure his safety.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in figures are provided for illustrative purpose only and should not be construed in limited sense. A person skilled in the art will appreciate alternate components that might be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants comprised in the scope of the invention.

What is claimed is:

1. A method of creating, assigning and executing an occupant safety test, the method comprising:
receiving, by a processor, details of an organization, wherein the details comprise a location of the organization, wherein the organization situates at different locations, and wherein the location indicates a structure belonging to the organization;
receiving, by the processor, a list of occupants in each location;
creating, by the processor, one or more zones corresponding to each of the locations, each zone indicating a sub-portion of the location, wherein each zone comprises fixtures, and wherein the fixtures comprise one of safety equipment and an emergency door physically present in the zone;
creating, by the processor, an occupant safety test for each occupant in each of the zones, wherein the occupant safety test is created by generating a zone plan of the zone, wherein the zone plan indicates digitized floor plan of the zone, wherein the zone plan is generated by superimposing safety fixtures over physical location of the fixtures in the zone, wherein the safety fixtures indicate symbols on the zone plan for identifying corresponding fixtures in the zone, wherein the occupant safety test indicates a test created for the occupant in the zone to identify a safety fixture corresponding to the physical fixture in the zone in order to get familiarized with the physical location of the fixtures in the zone for use in an emergency situation.
assigning, by the processor, the occupant safety test created to the occupant in the location; and
executing, by the processor, the occupant safety test by identifying the safety fixtures on the zone plan to get familiarized with the physical location of the fixtures in the zone for use in the emergency situation.

2. The method of claim 1, further comprising transmitting the occupant safety test to a user device, wherein the occupant safety test transmitted is displayed to the occupant for executing the occupant safety test.

3. The method of claim 1, further comprising transmitting the occupant safety test via a Uniform Resource Locator (URL).

4. The method of claim 1, further comprising tagging information having placement of the fixtures and protocols to be followed by the occupant for operating the fixtures in the emergency situation.

5. The method of claim 1, wherein the zone plan is generated by mapping the safety fixtures on the zone plan corresponding to the location of the fixtures in the zone.

6. The method of claim 1, wherein the zone plan comprises longitude and latitude coordinates of the safety features corresponding to the fixtures in the zone.

7. A system for creating, assigning and executing an occupant safety test, the system comprising:
a processor; and
a memory coupled to the processor, wherein the processor is configured to execute program instructions stored in the memory, to:
receive details of an organization, wherein the details comprise a location of the organization, wherein the organization situates at different locations, and wherein the location indicates a structure belonging to the organization;
receive a list of occupants in each location;
create one or more zones corresponding to each of the locations, each zone indicating a sub-portion of the location, wherein each zone comprises fixtures, and wherein the fixtures comprise one of safety equipment and an emergency door physically present in the zone;
create an occupant safety test for each occupant in each of the zones, wherein the occupant safety test is created by generating a zone plan of the zone, wherein the zone plan indicates digitized floor plan of the zone, wherein the zone plan is generated by superimposing safety fixtures over physical location of the fixtures in the zone, wherein the safety fixtures indicate symbols on the zone plan for identifying corresponding fixtures in the zone, wherein the occupant safety test indicates a test created for the occupant in the zone to identify a safety fixture corresponding to the physical fixture in the zone in order to get familiarized with the physical location of the fixtures in the zone for use in an emergency situation.
assign the occupant safety test created to the occupant in the location; and
execute the occupant safety test by identifying the safety fixtures on the zone plan to get familiarized with the physical location of the fixtures in the zone for use in the emergency situation.

8. The system of claim 7, wherein the processor executes the program instructions to transmit the occupant safety test to a user device, wherein the occupant safety test transmitted is displayed to the occupant for executing the occupant safety test.

9. The system of claim 7, wherein the processor executes the program instructions to transmit the occupant safety test to a user device, and wherein the user device comprises one of a computer, a laptop, a desktop computer, a mobile device, a navigation system, a tablet, and a wearable device.

10. The system of claim 7, wherein the processor executes the program instructions to transmit the occupant safety test to a user device, wherein the occupant safety test is transmitted via a Uniform Resource Locator (URL).

11. The system of claim 7, wherein the processor further executes the program instructions to tag information having placement of the fixtures and protocols to be followed by the occupant for operating the fixtures in the emergency situation.

12. The system of claim 7, wherein the zone plan is generated by mapping the safety fixtures on the zone plan corresponding to the location of the fixtures in the zone.

13. The system of claim 7, wherein the zone plan comprises longitude and latitude coordinates of the safety features corresponding to the fixtures in the zone.

14. The system of claim 7, wherein the safety equipment comprises one of a first aid kit and a fire extinguisher.

15. A non-transitory computer readable medium embodying a program executable in a computing device for creating, assigning and executing an occupant safety test, the program comprising:
a program code for receiving details of an organization, wherein the details comprise a location of the organization, wherein the organization situates at different locations, and wherein the location indicates a structure belonging to the organization;
a program code for receiving a list of occupants in each location;
a program code for creating one or more zones corresponding to each of the locations, each zone indicating a sub-portion of the location, wherein each zone comprises fixtures, and wherein the fixtures comprise one of safety equipment and an emergency door physically present in the zone;
a program code for creating an occupant safety test for each occupant in each of the zones, wherein the occupant safety test is created by generating a zone plan of the zone, wherein the zone plan indicates digitized floor plan of the zone, wherein the zone plan is generated by superimposing safety fixtures over physical location of the fixtures in the zone, wherein the safety fixtures indicate symbols on the zone plan for identifying corresponding fixtures in the zone, wherein the occupant safety test indicates a test created for the occupant in the zone to identify a safety fixture corresponding to the physical fixture in the zone in order to get familiarized with the physical location of the fixtures in the zone for use in an emergency situation.
a program code for assigning the occupant safety test created to the occupant in the location; and
a program code for executing the occupant safety test by identifying the safety fixtures on the zone plan to get familiarized with the physical location of the fixtures in the zone for use in the emergency situation.

16. The program of claim 15, further comprises a program code for transmitting the occupant safety test to a user device.

17. The program of claim 15, further comprises a program code for transmitting the occupant safety test via a Uniform Resource Locator (URL).

18. The program of claim 15, further comprises a program code for tagging information having placement of the fixtures and protocols to be followed by the occupant for operating the fixtures in the emergency situation.

19. The program of claim 15, wherein the zone plan is generated by mapping the safety fixtures on the zone plan corresponding to the location of the fixtures in the zone.

20. The program of claim 15, wherein the zone plan comprises longitude and latitude coordinates of the safety features corresponding to the fixtures in the zone.
